(19) United States
(12) Patent Application Publication
(10) Pub. No.: US 2018/0157778 A1
(43) Pub. Date: Jun. 7, 2018

(54) SIDE-BY-SIDE INTERACTIVE CIRCUIT DESIGN PANEL

(71) Applicant: TEXAS INSTRUMENTS INCORPORATED, DALLAS, TX (US)

(72) Inventors: DIEN ANH MAC, SAN JOSE, CA (US); KAITLIN ROSE KIRASICH, MOUINTAIN VIEW, CA (US); JEFF PERRY, CUPERTINO, CA (US)

(21) Appl. No.: 15/368,155

(22) Filed: Dec. 2, 2016

(51) Int. Cl. G06F 17/50

(52) U.S. Cl. CPC G06F 17/5045; G06F 2217/06; G06F 17/5068; G06F 17/5009

(57) ABSTRACT

A design interface can provide an interactive circuit design panel for a given circuit solution operating at a set of specifications. The design interface can switch to a side-by-side design panel in response to selection of at least one compatible circuit solution selected from a list of compatible circuit solutions. The side-by-side design panel can concurrently characterize the given circuit solution operating at the set of specifications and the at least one compatible circuit solution operating at the set of specifications.

### TECHNICAL FIELD

This disclosure relates to a design interface. More particularly, this disclosure relates to a design interface that provides a side-by-side interactive circuit design panel.

### BACKGROUND

Electrical simulators allow a user to conduct an electrical simulation of a pre-existing electrical schematic (or circuit). The user can observe the performance of the circuit under simulated operating conditions. The user can change simulation related parameters using a pre-defined reference circuit.

To design a circuit solution, operational parameters including an input voltage, an output voltage and an output current can be pre-defined. In addition to these operational parameters, additional design priorities such as power efficiency, component and printed circuit board footprint size and overall component cost are considerations when designing a circuit solution. Due to the numerous available circuit components (e.g., integrated circuit (IC) chips and passive circuit components) and other constraints, creating and optimizing a circuit solution may be a long and tedious process.

### SUMMARY

One example relates to a non-transitory machine readable medium that stores machine readable instructions. The machine readable instruction can include a design interface. The design interface can provide an interactive circuit design panel for a given circuit solution operating at a set of specifications. The design interface can switch to a side-by-side design panel in response to selection of at least one compatible circuit solution selected from a list of compatible circuit solutions. The side-by-side design panel can concurrently characterize the given circuit solution operating at the set of specifications and the at least one compatible circuit solution operating at the set of specifications.

Another example relates to a server that includes a non-transitory machine readable memory and one or more processors that access the memory and execute the machine readable instructions. The machine readable instructions can include a design interface that provides an interactive circuit design panel for a given circuit solution operating at a set of specifications. The machine readable instructions can also include a solution engine that provides a list of circuit solutions that are compatible with the given circuit solution. The machine readable instructions can further include a circuit simulator that provides at least one compatible circuit solution selected from the list of circuit solutions that are compatible with the given circuit solution in response to user input at the interactive circuit design panel. The design interface can switch to a side-by-side design panel in response receipt of the at least one compatible circuit solution from the circuit simulator. The side-by-side design panel can characterize the given circuit solution operating at the set of specifications and the at least one compatible circuit solution operating at the set of specifications.

Yet another example relates to a method that can include providing an interactive circuit design panel for a given circuit solution characterizing a circuit implementing a given integrated circuit (IC) chip at a set of specifications. The method can also include selecting a compatible circuit solution from a list of circuit solutions compatible with the given circuit solution. The method can further include switching from the interactive circuit design panel to a side-by-side interactive circuit design panel for the given circuit solution operating at the set of specifications and the compatible circuit solution operating at the set of specifications.

### BRIEF DESCRIPTION OF THE DRAWINGS

FIG. 1 illustrates an example of a system for providing an interactive circuit design panel.

FIG. 2 illustrates an example of a workbench server.

FIG. 3 illustrates a screenshot of a user interface with information characterizing a circuit component.

FIG. 4 illustrates an example of an interactive circuit design panel in a schematic view.

FIG. 5 illustrates another example of an interactive circuit design panel in a schematic view.

FIG. 6 illustrates an example of an interactive circuit design panel in a compare view.

FIG. 7 illustrates an example of a side-by-side interactive circuit design panel in a schematic view.

FIG. 8 illustrates an example of a side-by-side interactive circuit design panel in a graphs view.

FIG. 9 illustrates an example of a side-by-side interactive circuit design panel in a bill of materials view.

FIG. 10 illustrates an example of a side-by-side interactive circuit design panel in an operational values view.

FIG. 11 illustrates an example of a side-by-side interactive circuit design panel in a printed circuit board layout view.

FIG. 12 illustrates a flowchart of an example method for determining a circuit solution.

### DETAILED DESCRIPTION

Some manufactures of integrated circuit (IC) chips provide compare tools that are focused around the characteristics or features of each IC chip. These compare tools are similar to a parametric search to allow a compare between one IC chip and another IC chip. These compare tools do not take into account the final design solution based on user controlled specifications and/or operating environment. Moreover, these compare tools fail to provide a full picture of a whole circuit solution set.

This disclosure relates to a design interface that provides a side-by-side interactive circuit design panel that allows for comparison of a given circuit solution with another solution in a side-by-side view. The side-by-side interactive circuit design panel allows a user to observe how the given and the other circuit solutions operates under different specifications, including operational parameters (voltage, current) or the operating environment (ambient operating temperature).

The side-by-side interactive circuit design panel can assist a user in selecting a most effective circuit solution for a particular application rather than focusing only on characteristics and features of individual IC chips while trying to compare the IC chips without the complete design circuit around each IC chip. For example, a controller IC chip can have a lower cost and handle higher current when compare with an integrated IC chip switcher, but the circuit solution implementing the controller IC chip may be more complex to build and the final design may be more costly when compared to the circuit solution implementing the IC chip switch.

The side-by-side interactive circuit design panel allows the user to view the final design circuitry including viewing a bill of materials (BOM), a design schematic, operating values, and allows the user to compare the current solution with other compatible solutions that can be configured to operate under the same set of specifications.

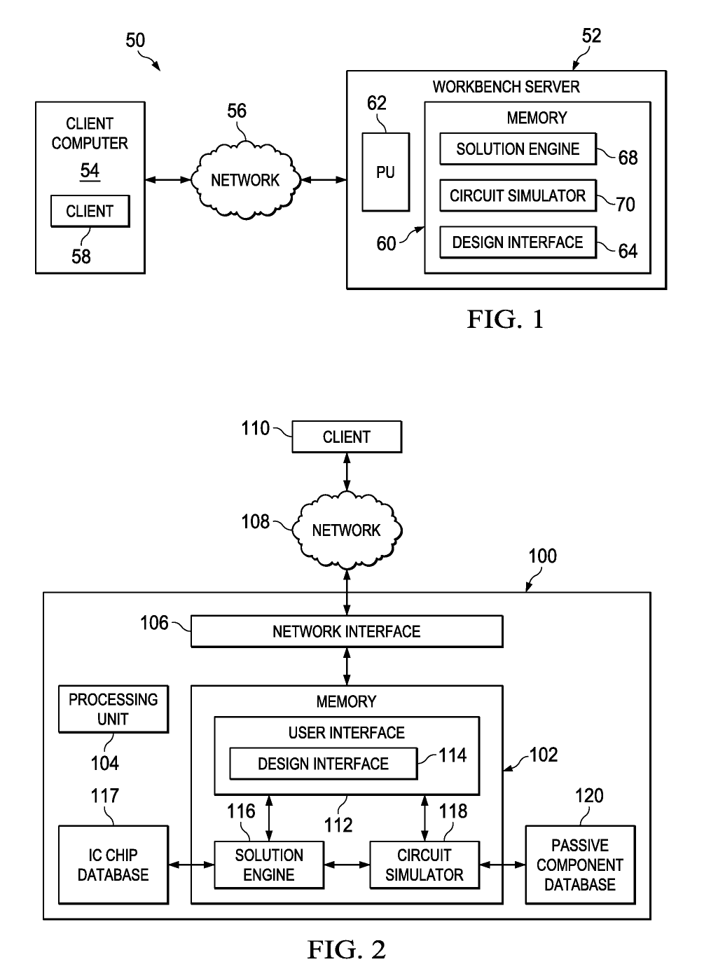

FIG. 1 illustrates an example of a system 50 for providing an interactive circuit design panel (e.g., interactive circuit designs) that includes a workbench server 52 that can communicate with a client device 54 over a network 56. The network 56 could be, for example, a public network, such as the Internet, a private network (e.g., an intranet) or a combination thereof (e.g., a virtual private network).

The client computer 54 can be, for example, a personal computer (e.g., a desktop or laptop computer), a handheld computing device (e.g., a smartphone or tablet), etc. The client computer 54 can include a memory (e.g., a machine readable medium) for storing machine readable instructions. The client computer 54 can also include a processing unit 62 (e.g., one or more processor cores) for accessing the memory and executing the machine readable instructions. The client computer 54 can include a client 58 executing thereon. In some examples, the client 58 can be representative of a web browser and/or a plugin operating on the web browser. In other examples, the client 58 can be a stand-alone application.

The workbench server 52 can be implemented on a distributed computing system (e.g., a cloud server) or on a stand-alone computing device. The workbench server 52 can include a non-transitory machine readable memory 60 and a processing unit 62 (e.g., one or more processor cores) for accessing the memory 60 and executing machine readable instructions. In situations where the workbench server 52 is implemented in a distributed computing system, the hardware of the workbench server 52 can be representative of resources allocated across the distributed computing system (e.g., virtual computing resources). Moreover, in some situations, the features of the workbench server 52 can be implemented on multiple servers.

The client 58 can communicate with the workbench server 52 via the network 56. In particular, the client 58 can communicate with a design interface 64 (e.g., a web interface engine) stored in the memory 60 of the workbench server 52. The design interface 64, along with the client 58 provides a graphical user interface (GUI) that allows a user of the client computer 54 to select a circuit component, which can be referred to as a selected circuit component. The selected circuit component could be, for example, an integrated circuit (IC) chip, a transistor, a light emitting diode (LED), or nearly any other discrete circuit component.

Upon choosing the selected circuit component, in response to user input at the client 58, the design interface 64 can actuate a solution engine 68 of the workbench server 52. The solution engine 68 can search a database (e.g., a circuit component database) for circuit components that are compatible with the selected component. Additionally, a circuit simulator 70 can calculate an initial circuit solution based on the selected circuit component, the list of compatible circuit compatible circuit components and a set of initial specifications (e.g., operational parameters and design priorities). The design interface 64 can output (via the client 58) an interactive circuit design panel of the initial circuit solution. As used herein, the term “circuit solution” characterizes information sufficient for implementing (fabricating) an electrical circuit that actuates a specific component (e.g., an IC chip). A circuit solution can include, but is not limited to a circuit schematic, a bill of materials (BOM), operational values, a footprint size, a BOM cost, a power efficiency, etc.

As used herein, the term “interactive circuit design panel” refers to a GUI, such as a web page, an applet or a stand-alone application that provides multiple viewing options for different views of a circuit solution as well as tools for modifying specifications of the circuit solution. These views may include, but are not limited to, a circuit schematic view, a performance graph view, a BOM view, operational values view a printed circuit board (PCB) layout view, etc. Additionally, as noted the interactive circuit design panel provides options for modifying the specifications of the circuit solution. More particularly, the modification options can provide features to allow modifications to operational parameters of the initial circuit solution. For example, the interactive circuit design panel can provide user controls (e.g., fields, dialog boxes, radio buttons, etc.) that allows for control of an input voltage (Vᵢₙ), an output voltage (Vₒᵤₜ), an output current (Iₒᵤₜ), one or more cutoff frequencies, and/or an ambient operating temperature (which can alternatively be referred to as an operating environment parameter). Additionally or alternatively, the interactive circuit design panel can include user controls that allows for design modifications based on user selected design priorities. Such design priorities could be for example, a BOM cost, a footprint size of the circuit solution, a power efficiency of the circuit solution, etc. The interactive circuit design panel can also provide a comparison option that allows for a search of comparable circuit solutions that employ a different circuit component than the selected circuit component. In particular, the compare option (when actuated) causes the design interface 64 to query the solution engine 68 for a list of compatible circuit solutions.

In some examples, based on the user interaction with the controls of the interactive circuit design solution, the design interface 64 can extract the operational parameters and the design priorities. The design interface 64 can provide the initial circuit solution, the operational parameters and the design priorities to the circuit simulator 70 of the workbench server 52 that generate a modified circuit solution.

To generate the modified circuit solution, the circuit simulator 70 can access a component database to retrieve operational specifications of circuit components (e.g., passive circuit components) that achieve the operational parameters based on the design priorities that are provided by the design interface 64. The circuit simulator 70 can employ a rule-based or machine learning based algorithm to design the modified circuit solution. The circuit simulator 70 can return the modified circuit solution to the design interface 64. The design interface 64 can output an interactive circuit design panel of the modified circuit solution.

As noted, the interactive circuit design panel includes a compare option. Upon actuation of the compare option in the updated circuit solution, the compare option can cause the design interface 64 to interact with the solution engine 68 (and/or the circuit simulator 70) to provide K number of compatible circuit solutions, where K is an integer greater than or equal to one. Upon selection of a compatible circuit solution (or multiple compatible circuit solutions), the design interface 64 provides a side-by-side interactive circuit design panel for the updated circuit solution and the compatible circuit solution (or multiple compatible circuit solutions). The side-by-side interactive circuit design panel concurrently depicts the updated circuit solution and the compatible circuit solution.

In the side-by-side interactive circuit design panel, the same options for view and modification can be provided. However, upon selection a modification to an operational parameter and/or a design priority, the design interface 64 interacts with the circuit simulator 70 to apply selected operational parameters and/or design priorities to each circuit solution in the side-by-side interactive circuit design panel. In this manner, changes made in the side-by-side interactive circuit design panel appear in near real-time to a user of the client computer 54 (e.g., within 20 seconds).

By employment of the workbench server 52 a user of the client computer 54 can efficiently evaluate and adjust a circuit solution (circuit design) to arrive a circuit solution that is tailored to the specific needs of the environment in which the circuit solution is to operate. In particular, constraints (e.g., cost, power use, thermal tolerance, etc.) are often unique to each environment of application and small changes to the operational parameters and/or the design priorities of each circuit can have a significant effect on the circuit solution. Thus, in many such situations, through employment of the workbench server 52, a circuit component (e.g., a particular IC chip) that was originally believed by the user to be a “best choice” for a particular application may be revealed to a less effective circuit solution than another circuit solution (using another IC chip) revealed through employment of the side-by-side interactive circuit design panel.

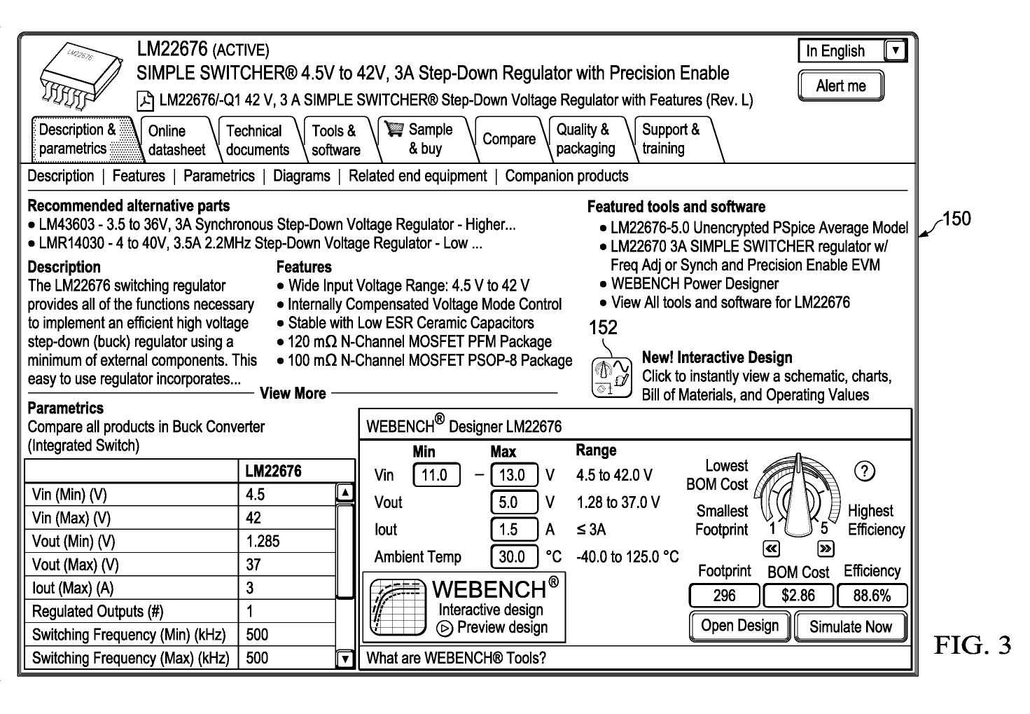

FIG. 2 illustrates an example of a workbench server 100 for providing interactive circuit design panels. The workbench server 100 can be employed, for example, to implement the workbench server 52 of FIG. 1. The workbench server 100 can include a memory 102 that can store machine readable instructions. The memory 102 could be implemented, for example, as non-transitory computer readable media, such as volatile memory (e.g., random access memory), nonvolatile memory (e.g., a hard disk drive, a solid state drive, flash memory, etc.) or a combination thereof. The workbench server 100 can also include a processing unit 104 to access the memory 102 and execute the machine-readable instructions. The processing unit 104 can include, for example, one or more processor cores. The workbench server 100 can include a network interface 106 configured to communicate with a network 108. The network interface 106 could be implemented, for example, as a network interface card. The network 108 could be implemented, for example, as a private network (e.g., local area network or a carrier network) as a public network (e.g., the Internet), or a combination thereof (e.g., a virtual private network).

The workbench server 100 can be an application server. Accordingly, software components illustrated as executing on the workbench server 100 can execute on other servers. Moreover, the workbench server 100 could be implemented, for example in a computing cloud. In such a situation, features of the workbench server 100 such as the processing unit 104, the network interface 106, and the memory 102 could be representative of a single instance of hardware or multiple instances of hardware with applications executing across the multiple of instances (i.e., distributed) of hardware (e.g., computers, routers, memory, processors, or a combination thereof). Alternatively, the workbench server 100 could be implemented on a single dedicated computing device.

The workbench server 100 can communicate with a client 110 via the network 108. The client 110 can operate on a client computing device. The client 110 can be, for example, a web browser, a stand-alone application, a browser applet or plugin, etc. The client 110 can access a user interface 112 stored in the memory 102.

Operations of the workbench server 100 can be better understood with an extended example, hereinafter referred to as “the given example”. The user interface 112 can generate a GUI that is output at the client 110. The GUI can include, for example, a search engine that allows a user to search for a circuit component. In the given example, the circuit component is an IC chip, which IC chip can be referred to as a selected IC chip. In other examples, other circuit components (e.g., transistors, LEDs, or nearly any discrete circuit component) can be selected. FIG. 3 illustrates a screenshot 150 that can be provided by the user interface 112 via the client 110 upon choosing the selected IC chip. As illustrated in the screenshot 150, general operational information regarding the selected IC chip is provided. Additionally, as shown in the screenshot 150, the user interface 112 can provide a button 152 (e.g., a virtual button) for initiating an interactive circuit design panel for the selected IC chip.

In the given example, in response to actuation of the button 152, a design interface 114 (which can be a component of the user interface 114) can provide data characterizing the selected IC chip to a solution engine 116 of the memory 102. In response, the solution engine 116 can retrieve a circuit solution from an IC chip database 117 (or other circuit component database) for the selected IC chip. The solution engine 116 can analyze (e.g., screen and/or review) specific circuit components compatible with the retrieved circuit solution to generate a list of compatible parts. For instance, as noted, in the given example, the selected IC chip is a step-down voltage regulator. In such a situation, the retrieved circuit solution can include a diode coupled to the selected IC chip. The solution engine 116 can identify a list of diodes (e.g., a specific model numbers) that are employable in the circuit solution.

The solution engine 116 can provide the circuit solution and the list of compatible components to a circuit simulator 118 stored in the memory 102. The circuit simulator 118 can apply rules and/or machine learning techniques to synthesize a model of the circuit solution for the design interface 114. In particular, the circuit simulator 118 can retrieve operational parameters for each component in the list of compatible components from a passive component database 120 (or other data structure) to generate a model of the circuit solution. The model of the circuit solution includes information sufficient to simulate operation of the circuit solution at a specific set of parameters and design priorities. The model of the circuit solution can be provided to the design interface 114.

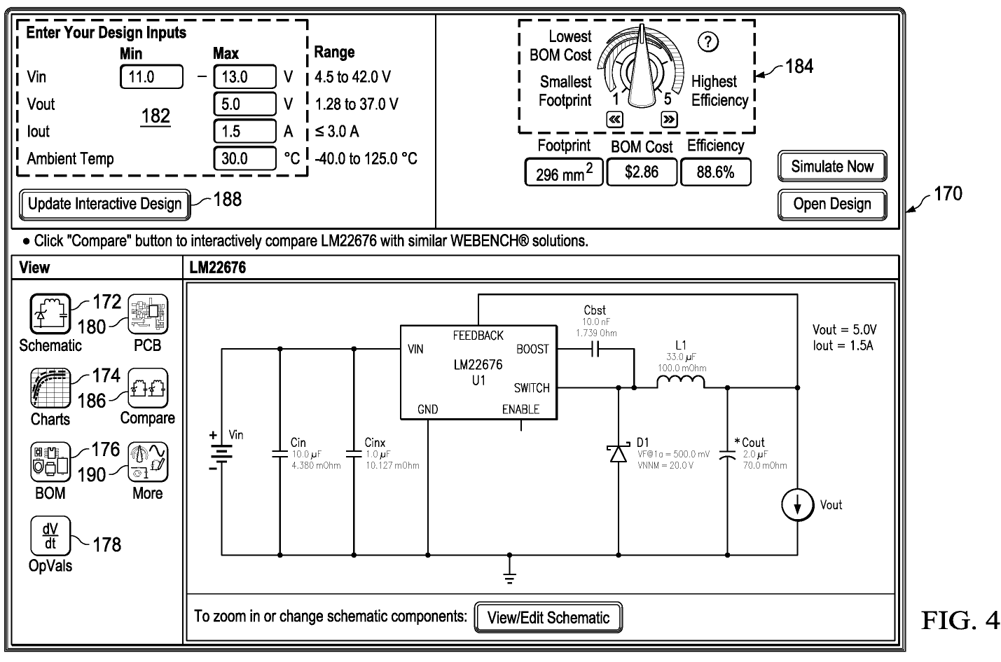

The design interface 114 can provide an interactive circuit design panel for the model of the circuit solution for the selected IC with an initial set of parameters and design priorities, which can be referred to as an initial circuit solution. FIG. 4 illustrates an example of a screenshot of an interactive circuit design panel 170 provided by the design interface 114 that could be output by the client 110 in the given example. As illustrated, the interactive circuit design panel includes buttons 172, 174, 176, 178 and 180 (e.g., virtual buttons) for controlling views of the initial circuit solution.

In the example illustrated in FIG. 4, the schematic view of the circuit solution is output, which can be selected with a schematic view button 172. Moreover, a graph view button 174 provides graphs of operational characteristics (e.g., power efficiency and/or duty cycle curves). A BOM view button 176 provides a detailed list of part numbers and attributes for each circuit component in the circuit solution. An operational values button 178 provides a list of values for operational characteristics of the circuit solution. Additionally, a PCB view button 180 provides a PCB layout for the circuit solution.

The interactive circuit design panel 170 provided by the design interface 114 includes mechanisms for modifying specifications of the circuit solution. In particular, the interactive circuit design panel includes fields 182 (or other user-interactive features) for user input that can change operational parameters of the circuit solution. As illustrated, in the given example, the fields 182 include an input voltage Vᵢₙ an output voltage Vₒᵤₜ, an output current Iₒᵤₜ and an ambient operational temperature. By editing the values in the fields 182, a user of the client 110 can adjust the operational parameters of the circuit solution to fit a particular environment of application.

Additionally, the interactive circuit design panel provided by the design interface 114 includes priority controls 184 for setting weights of design priorities of the circuit solution. In the present example, a virtual knob is illustrated, but in other example, other user-interactive features (e.g., radio buttons, sliding scales, etc.) could alternatively or additionally be employed. The design priorities can include a footprint size, a BOM cost and/or a power efficiency. In the given example illustrated in the interactive circuit design panel 170, each of the footprint size, the BOM cost and the power efficiency are given equal priority.

The interactive circuit design panel 170 provided by the design interface 114 also includes a compare view button 186. When actuated, the compare view button 186 provides a list of compatible circuit solutions that employs a different IC chip (or other discrete circuit component) than the selected IC chip.

Furthermore, the list of options in the interactive circuit design panel 170 is not meant to be exhaustive. In other examples, more or less options can be presented. Furthermore, in some examples, an auxiliary button 190 can be included to provide a window for further operations, including but not limited to electrical and/or thermal simulation, re-compensation, design optimization, report generation, etc.

In the given example, it is presumed that the output current, Iₒᵤₜ needs to be 2.0 amperes (A). Additionally, it is presumed that the lowest BOM cost should be given the highest priority. Thus, a user of the interactive circuit design panel 170 can change the value of the output current, Iₒᵤₜ to 2.0 A and adjust the priority controls 184 to set the BOM cost to a highest design priority. In some examples, upon manipulation of the fields 182 and the priority controls 184, an update button 188 (a virtual button) can be actuated in response to user input.

Referring back to FIG. 2, actuation of the update button 188 causes the design interface 114 to provide data characterizing the selected IC chip, the operational parameters and the design priorities to the solution engine 116. In response, the solution engine 116 can retrieve a circuit solution from an IC chip database 117 for the selected IC chip that meets the updated operational characteristics. The solution engine 116 can analyze (e.g., screen and/or review) the retrieved circuit solution for specific circuit components compatible with the retrieved circuit solution to generate a list of compatible parts.

The solution engine 116 can provide the circuit solution for the updated operational characteristics and the list of compatible components to the circuit simulator 118. The circuit simulator 118 can apply rules and/or machine learning techniques to synthesize an updated model of the circuit solution for the design interface 114. In particular, the circuit simulator 118 can retrieve operational parameters for each component in the list of compatible components from the passive component database 120 to generate a model of the circuit solution. The model of the circuit solution includes information sufficient to simulate operation of the circuit solution at the set of operational parameters and design priorities set in the interactive circuit design panel. The model of the circuit solution can be provided to the design interface 114. The design interface 114 can provide an updated (modified) interactive circuit design panel to the client 110.

In some examples, the passive component database 120 is a dynamic database. In such a situation, the passive component database 120 may be updated frequently (e.g., on a per hour basis) via a plurality of different web services. Such updates can include changes to pricing and/or availability of particular passive components. Based on these updates to the passive component database 120, the model of the circuit solution generated by the circuit simulator 118 would change over time in a corresponding manner. For instance, in a situation where cost is set to a highest priority, a change in the price to one or more passive circuit components may affect the total BOM cost for the circuit solution generated by the circuit simulator 118. Accordingly, if the change in price is sufficiently large, the ranking of the particular model of the circuit solution may also change.

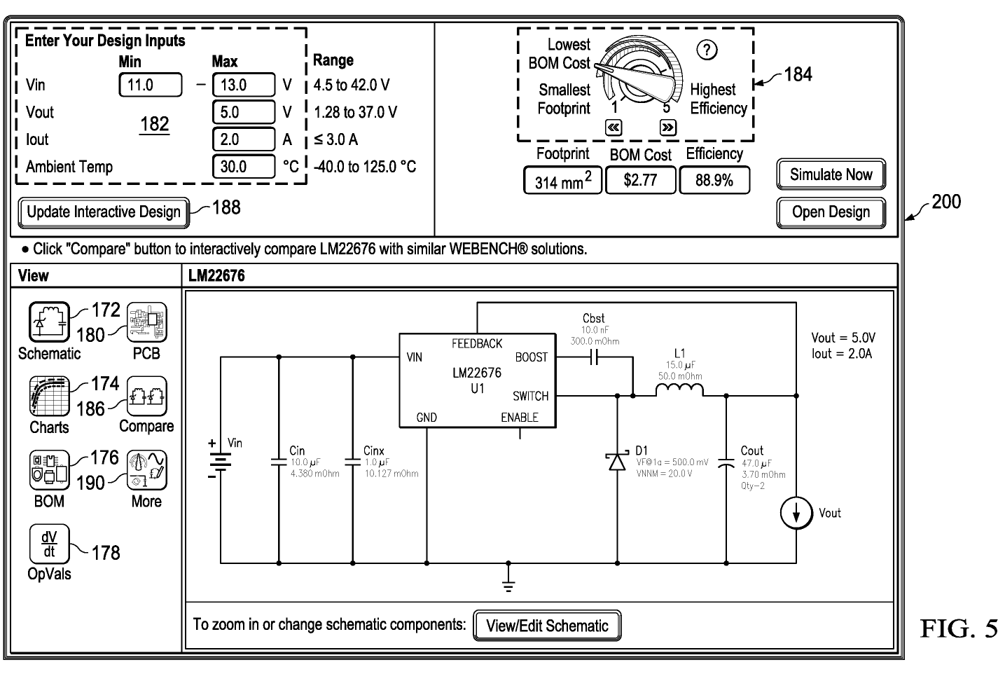

FIG. 5 illustrates a screenshot of the interactive circuit design panel 200 provided by the design interface 114 wherein a field 182 has been changed from 1.5 A to 2.0 A, and the lowest cost BOM has been set to a highest design priority, as explained in the given example. For purposes of simplification of explanation, the same reference numbers are used in FIGS. 4-11 to denote the same structure. The interactive circuit design panel 200 provides the same (or similar) options to the user for the updated (modified) circuit solution as the initial circuit solution.

The compare view button 186 (when actuated) provides a list of circuit solutions that are compatible with the updated circuit solution. As used herein, the term “compatible circuit solution” denotes a circuit solution that can operate within the operational parameters defined in the fields 182 and operates with an IC chip other than the selected IC chip. To generate the list of compatible circuit solutions, the interactive circuit design panel provides the selected IC chip, along with the operational parameters and the design priorities to the solution engine 116. The solution engine 116 can retrieve each circuit solution from the IC chip database 117 that has operational parameters that overlaps the operational parameters for the updated circuit solution. The solution engine 116 can sort (e.g., rank) the list of compatible circuit solutions based on the operational parameters and the design priorities relative to the updated circuit solution. The solution engine 116 can return the list of compatible circuit solutions, which can be output by the design interface 114.

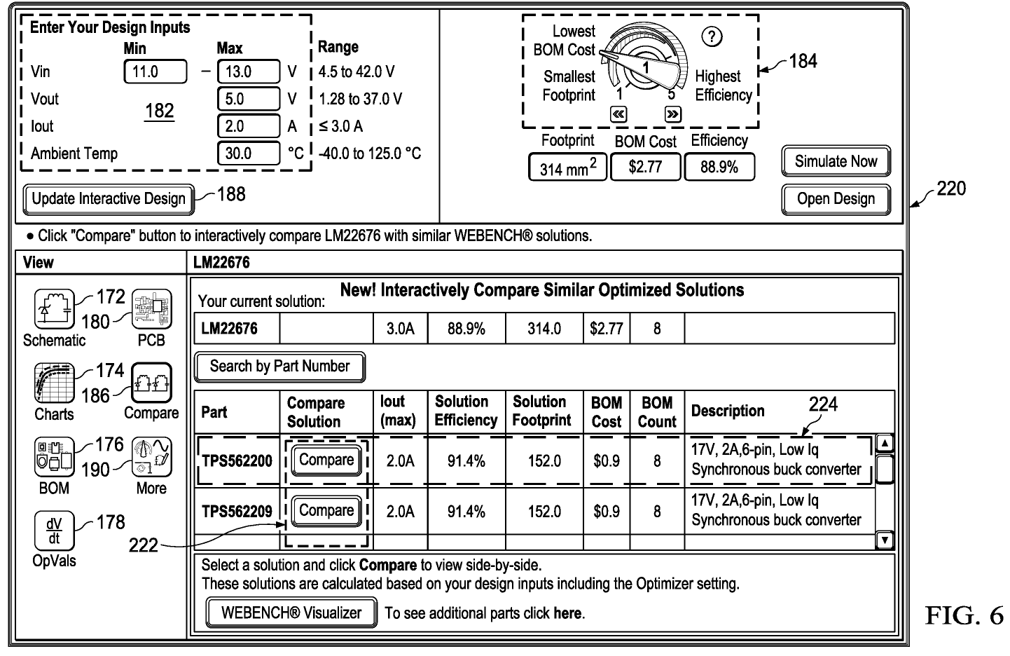

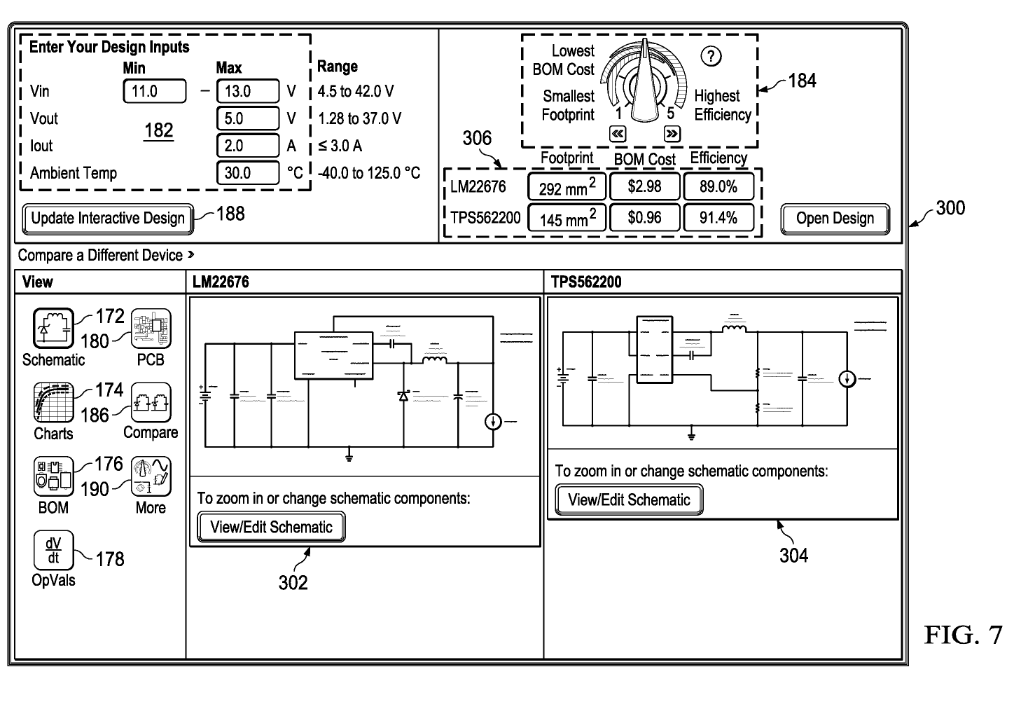

FIG. 6 illustrates an example of an interactive circuit design panel 220 for the updated circuit solution upon actuation of the compare view button 186. The user can actuate a solution compare button 222 for each circuit solution that the user desires to compare against the updated circuit solution.

In the list of circuit solutions, each circuit solution can include data characterizing an IC chip employed by the circuit solution, a maximum output current Iₒᵤₜ (or other operational parameter), a solution power efficiency, a footprint size, a BOM cost and a BOM count. In the given example, it is presumed that the user actuates only one compare button 222, to select a particular compatible circuit solution 224 for comparison (referred herein as “the compatible circuit solution”) but in other examples, more than one circuit solution can be selected for comparison.

Referring back to FIG. 2, in the given example, upon selection of the compatible circuit solution 224, the interactive circuit design panel provided by the design interface 114 provides the compatible circuit solution, the operational parameters and the design priorities to the circuit simulator 118. The circuit simulator 118 can generate a model for the compatible circuit solution in a similar manner to process described for the updated circuit solution. The model for the compatible circuit solution can be provided to the design interface 114.

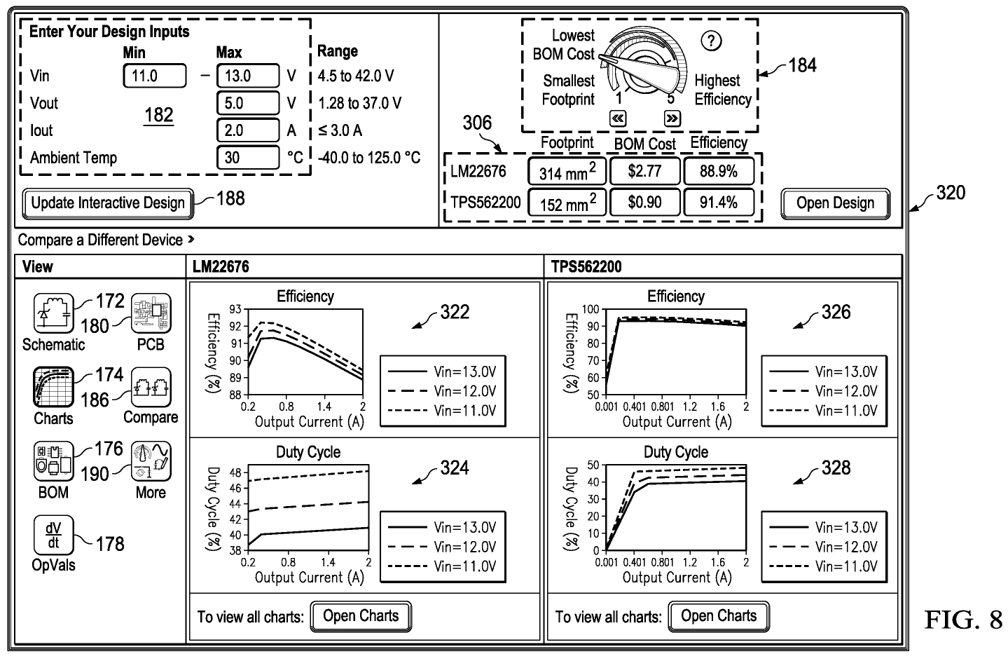

In response, the design interface 114 can switch from the (single) interactive circuit design panel (demonstrated in FIGS. 4-6) to a side-by-side interactive circuit design panel. FIG. 7 illustrates an example of a side-by-side interactive circuit design panel 300 that can be provided by the design interface 114 in the given example. The side-by-side interactive circuit design panel 300 provides the same or similar operations for two (or more) circuit solutions that were provided for a single circuit solution.

In the side-by-side interactive circuit design panel 300, the schematic view of the circuit solutions are shown. In particular, a circuit schematic for the updated circuit solution 302 and the compatible circuit solution and 304 are output at the client 110.

Additionally, in the schematic view (and every other view) of the side-by-side interactive circuit design panel 300, summary information 306 for the updated circuit solution and the compatible circuit solution can be provided. The summary information 306 provides data characterizing, for example, a footprint size, a BOM cost and a power efficiency of the updated circuit solution and the compatible circuit solution.

Upon actuation of the graphs view button 174, the design interface 114 can provide graphs of operational characteristics (e.g., power efficiency and/or duty cycle curves). FIG. 8 illustrates an example of a side-by-side interactive circuit design panel 320 that can be provided by the design interface 114 in the given example in the graphs view. In the side-by-side interactive circuit design panel 320, two (or more) sets of graphs are output. In particular, a power efficiency graph 322 and a duty cycle graph 324 are output for the updated circuit solution. Similarly, a power efficiency graph 326 and a duty cycle graph 328 are output for the compatible circuit solution. Moreover, in the side-by-side interactive circuit design panel 320, the power efficiency graph 322 for the updated circuit solution and the power efficiency graph 326 for the compatible circuit solution have different scales. In some examples, only one graph might be shown with lines on the same graph (at the same scale) for the power efficiency of the updated circuit solution and the compatible circuit solution. Similarly, the duty cycle graph 324 and the duty cycle graph 328 are plotted on different scales. Thus, the lines on the duty cycle graph 324 for the updated circuit solution and the duty cycle graph 328 for the compatible circuit solution could additionally or alternatively be plotted on the same graph with the same scale.

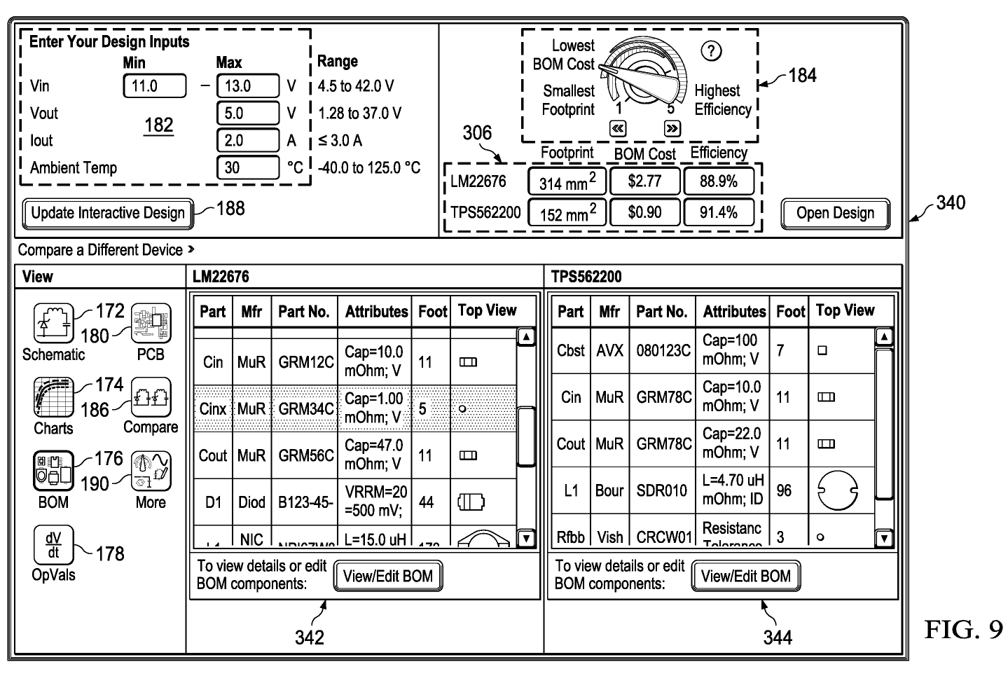

Upon actuation of the BOM view button 176, a BOM view of the updated circuit solution and the updated circuit solution can be provided by the design interface 114. FIG. 9 illustrates an example of a side-by-side interactive circuit design panel 340 that can be provided by the design interface 114 in the given example depicting the BOM view. In the BOM view, a BOM 342 is provided for the updated circuit solution and a BOM 344 is provided for the compatible circuit solution. The BOMs 342 and 344 can include part numbers, manufacturers, attributes, footprint size, drawings, cost, etc.

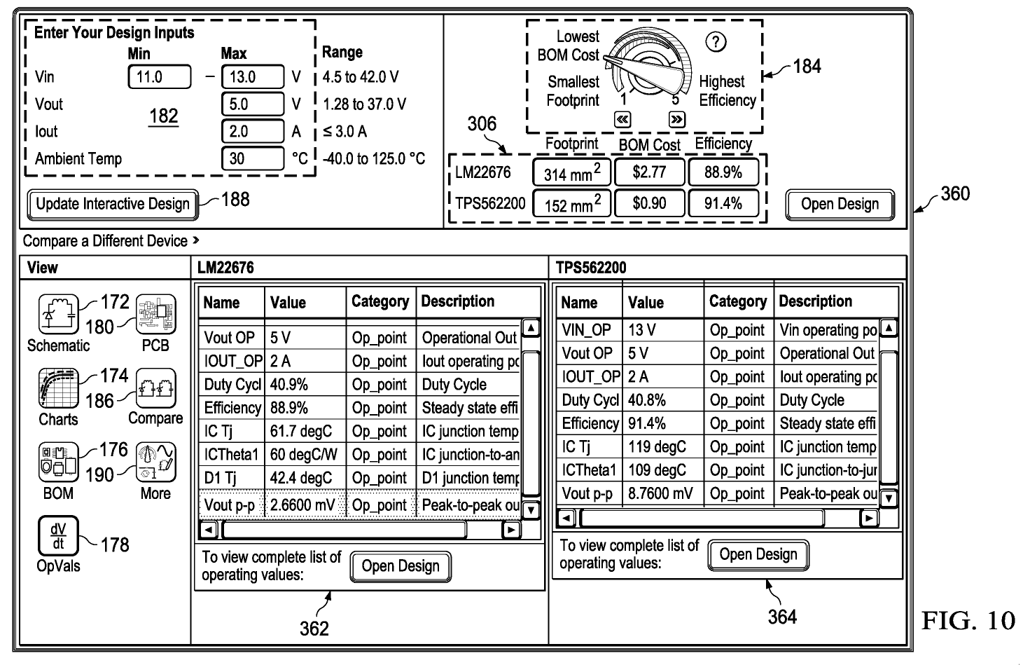

Upon actuation of the operational values button 178, the design interface 114 provides the operational values view for the updated circuit solution and the compatible circuit solution. FIG. 10 illustrates an example of a side-by-side interactive circuit design panel 360 that can be provided by the design interface 114 in the given example depicting an operational values view. In the side-by-side interactive circuit design panel 360, a list of values for operational characteristics 362 of the updated circuit solution and a list of values for operational characteristics 364 of the compatible circuit solution are provided.

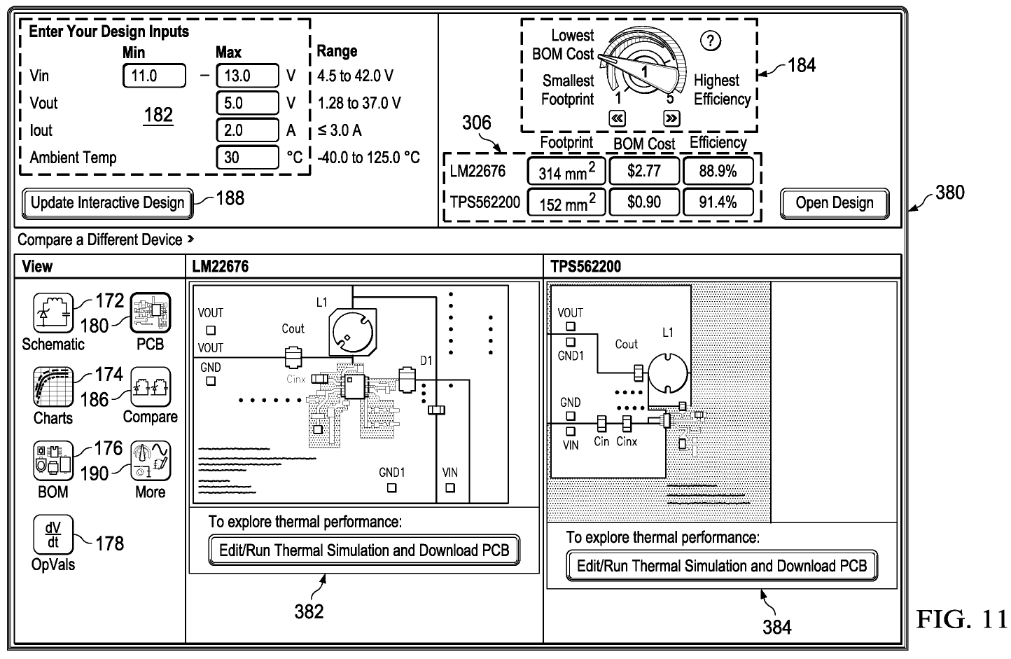

Upon actuation of the PCB view button 180, a PCB view of the updated circuit solution and the updated circuit solution can be provided by the design interface 114. FIG. 11 illustrates an example of a side-by-side interactive circuit design panel 380 that can be provided by the design interface 114 in the given example depicting the PCB view. In the PCB view, a PCB layout 382 of the updated circuit solution and a PCB layout 384 of the compatible circuit solution are output at the client 110.

Upon reviewing some (or all) of the views in the side-by-side interactive circuit design panel (depicted at 300, 320, 340, 360 at 380 in FIGS. 7-11), the user may elect to make further adjustments to the operational parameters via the fields 182 and/or the design priorities 184 and actuate the update button 188. Upon changes to the operational parameters in the fields 182 and/or the design priorities, the design interface 114 can provide the fields and the design priorities to the circuit simulator 118. In response, the circuit simulator 118 can recalculate a model for each of the updated circuit solution and the compatible circuit solution in a manner described herein.

Referring back to FIG. 2, by employing the side-by-side interactive panel provided by the design interface 114, the user of the client 110 can identify a most effective circuit solution based on predetermined specifications, which can include a operational parameters as well as a combination of footprint size, BOM cost and/or power efficiency, etc. For instance, a controller IC chip may have a lower cost and have a higher maximum output current (Iₒᵤₜ) when compared to an IC chip voltage switcher. However, through employment of the interactive circuit design panel, a user may discover that the circuit solution to implement the controller may be more complex than that of the IC voltage switcher, such that the BOM cost to implement the circuit solution with the IC chip voltage switcher may be less than the BOM cost to implement the IC chip controller, and that the maximum current output by the circuit solution with the IC chip voltage switcher may be sufficient for the particular environment in which a circuit is to be implemented. Accordingly, in this scenario, the user may elect to implement the circuit solution with the IC chip voltage switcher.

Furthermore, in the given example, the selected IC chip, namely part number LM22676 (a step-down voltage regulator) is evaluated in a circuit solution (the initial and updated circuit solution) and compared against a circuit solution employing part number TPS562200 (another step-down voltage regulator) with operational parameters and design priorities having been set to meet predetermined specifications. Upon reviewing the views of the circuit solutions in the side-by-side interactive circuit design panels 300, 320, 340, 360 and 380 (illustrated in FIGS. 7-11), it is apparent that the compatible circuit solution employing part number TPS562200 provides superior performance in nearly every metric. Thus, in the given example, a user of the client 110 evaluating the updated (or initial) circuit solution with the compatible circuit solution is likely to select the compatible circuit solution.

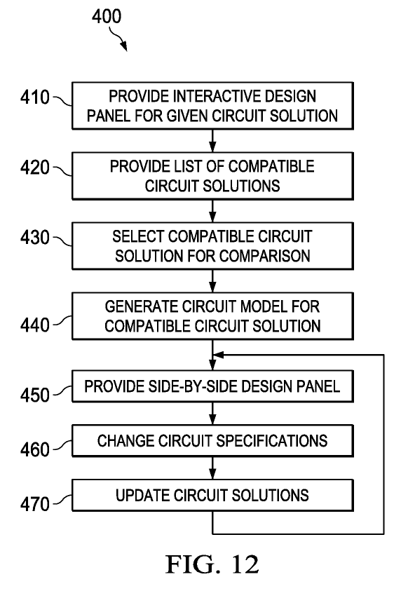

In view of the foregoing structural and functional features described above, example methods will be better appreciated with reference to FIG. 12. While, for purposes of simplicity of explanation, the example method of FIG. 12 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example method of FIG. 12 can be implemented as instructions stored in a non-transitory machine-readable medium. The instructions can be accessed by a processing resource (e.g., one or more processor cores) and executed to perform the methods disclosed herein.

FIG. 12 illustrates a flowchart of an example method 400 for determining a circuit solution. The method 400 could be implemented by a workbench server, such as the workbench server 52 illustrated in FIG. 1 and/or the workbench server 100 illustrated in FIG. 2. At 410 an interactive circuit design panel for a given circuit solution can be provided by a user interface (e.g., the design interface of FIG. 2 and/or the design interface 64 of FIG. 1). The given circuit solution can be generated a solution engine and a circuit simulator based on design specifications (e.g., operational parameters and design priorities) set in response to user input.

At 420, the interactive circuit design panel (in response to user input) can provide a list of circuit solutions compatible with the given circuit solution that can be generated and ranked by the solution engine. At 430, a compatible circuit solution can be selected from the list of compatible circuit solutions for comparison via the interactive circuit design panel in response to user input. At 440, the circuit simulator can generate a circuit model for the selected compatible circuit solution.

At 450, the design interface can provide (or switch to) a side-by-side design panel that (through user interaction) can provide multiple views of the given circuit solution and the compatible circuit solution concurrently. At 460, circuit specifications (e.g., operating parameters and/or design priorities) can be changed (adjusted) in response to user input at the side-by-side design panel. In response to the change in circuit specifications, at 470, the given circuit solutions and the compatible circuit solution can be updated. The method 400 can return to 450.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, solid-state storage devices, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A non-transitory machine readable medium storing machine readable instructions, the machine readable instructions comprising:
a design interface that provides an interactive circuit design panel for a given circuit solution operating at a set of specifications;
wherein the design interface switches to a side-by-side design panel in response to selection of at least one compatible circuit solution selected from a list of compatible circuit solutions, and the side-by-side design panel concurrently characterizes the given circuit solution operating at the set of specifications and the at least one compatible circuit solution operating at the set of specifications.

2. The medium of claim 1, wherein the given circuit solution and the other circuit solution each include different integrated circuit (IC) chips.

3. The medium of claim 1, wherein the side-by-side panel provides a plurality of different views of the given circuit solution and the at least one compatible circuit solution, wherein the different views are changeable in response to user input.

4. The medium of claim 3, wherein one of the plurality of different views provides a circuit schematic for the given circuit solution and a circuit schematic for the at least one compatible circuit solution.

5. The medium of claim 3, wherein one of the plurality of different views provides a bill of materials for the given circuit solution and a bill of materials for the at least one compatible circuit solution.

6. The medium of claim 3, wherein one of the plurality of different views provides a plurality of graphs characterizing operational characteristics of the given circuit solution and the at least one compatible circuit solution.

7. The medium of claim 3, wherein one of the plurality of different views provides a printed circuit board layout of the given circuit solution and the at least one compatible circuit solution.

8. The medium of claim 1, wherein the side-by-side interactive circuit design panel includes user-interactive features for changing the set of specifications.

9. The medium of claim 8, wherein a circuit simulator updates the given circuit solution and the compatible circuit solution in response to a change of one or more of the specifications in the set of specifications.

10. The medium of claim 9, wherein the set of specifications includes a weight of design priorities.

11. The medium of claim 10, wherein the design priorities comprises a bill of materials cost, a footprint size and a power efficiency.

12. The medium of claim 9, wherein the set of specifications comprises a plurality of operational parameters.

13. The medium of claim 12, wherein the set of operational parameters comprises an output current and an output voltage.

14. The medium of claim 12, wherein the set of operational parameters comprises an ambient operating temperature.

15. The medium of claim 1, wherein the side-by-side interactive circuit design panel provides summary information for the given circuit solution and the compatible circuit solution.

16. The medium of claim 15, wherein the summary information includes a footprint size, a bill of materials cost and a power efficiency for each of the given circuit solution and the at least one compatible circuit solution.

17. A server comprising:
a non-transitory machine readable memory; and
one or more processors that access the memory and execute the machine readable instructions, the machine readable instructions causing the one or more processors to:
provide an interactive circuit design panel for a given circuit solution operating at a set of specifications;
provide a list of circuit solutions that are compatible with the given circuit solution;
provide at least one compatible circuit solution selected from the list of circuit solutions that are compatible with the given circuit solution in response to user input at the interactive circuit design panel; and
switch the interactive circuit design panel to a side-by-side design panel in response to receipt of the at least one compatible circuit solution from the circuit simulator, and the side-by-side design panel characterizes the given circuit solution operating at the set of specifications and the at least one compatible circuit solution operating at the set of specifications.

18. The server of claim 17, wherein the set of specifications comprises operational parameters and design priorities and the circuit simulator updates the given circuit solution and the at least one compatible circuit solution in response to a change to the set of specifications.

19. A method comprising:
providing an interactive circuit design panel for a given circuit solution characterizing a circuit implementing a given integrated circuit (IC) chip at a set of specifications;
selecting a compatible circuit solution from a list of circuit solutions compatible with the given circuit solution in response to user input at the interactive circuit design panel; and
switching from the interactive circuit design panel to a side-by-side interactive circuit design panel for the given circuit solution operating at the set of specifications and the compatible circuit solution operating at the set of specifications.

20. The method of claim 19, further comprising:
changing one or more specifications in the set of specifications in response to user input at the side-by-side interactive circuit design;
updating the given circuit solution and the compatible circuit solution in response to the change in the one or more specifications; and
providing, via the side-by-side interactive circuit design panel, the updated given circuit solution and the updated compatible circuit solution.
